(19) United States
(12) Patent Application Publication
(10) Pub. No.: US 2026/0301668 A1
(43) Pub. Date: Oct. 1, 2026

(54) DISPLAY PANEL AND DISPLAY APPARATUS

(71) Applicants: CHENGDU BOE OPTOELECTRONICS TECHNOLOGY CO., LTD., Sichuan (CN); BOE TECHNOLOGY GROUP CO., LTD., Beijing (CN)

(72) Inventors: Yulong WEI, Beijing (CN); Rong WANG, Beijing (CN); Yujing LI, Beijing (CN); Mengmeng DU, Beijing (CN); Jun YAN, Beijing (CN); Qiwei WANG, Beijing (CN)

(21) Appl. No.: 18/992,228

(22) PCT Filed: Aug. 11, 2022
(86) PCT No.: PCT/CN2022/111756

§ 371 Date: Jan. 8, 2025

(51) Int. Cl. G09G 3/3233; G09G 3/32

(52) U.S. Cl. CPC G09G 3/3233; G09G 3/32; G09G 2300/0426; G09G 2300/0842; G09G 2300/0861

(57) ABSTRACT

A display panel has a display region and a peripheral region at least partially surrounding the display region, where the display region includes a secondary display region and a main display region located on at least one side of the secondary display region, and the secondary display region includes a light-transmitting region and a circuit region located on at least one side of the light-transmitting region. The display panel includes: a driving backplane, including multiple pixel circuits distributed in an array and multiple first reset signal lines; and multiple light-emitting devices, located on one side of the driving backplane, and including first light-emitting devices located in the main display region and the circuit region, and a second light-emitting device located in the light-transmitting region; the first light-emitting devices are connected to the first pixel circuits, and the second light-emitting device is connected to the second pixel circuit.

### TECHNICAL FIELD

This disclosure relates to the field of display technology, and specifically, to a display panel and a display device.

### BACKGROUND

With the development of display technology, FDC (Full Display with Camera) has been gradually used in display products due to its large screen-to-body ratio. As to full-screen display devices, optical components such as cameras are usually placed in the under-screen region of the display panel, thereby greatly increasing the screen-to-body ratio.

It should be noted that the information disclosed in the above background segment is only used to enhance understanding the background of this disclosure, and therefore may include information that does not constitute prior art known to those skilled in the art.

### SUMMARY

This disclosure provides a display panel and a display device.

According to an aspect of this disclosure, a display panel is provided and includes a display region and a peripheral region at least partially surrounding the display region, where the display region includes a secondary display region and a main display region located on at least one side of the secondary display region, and the secondary display region includes a light-transmitting region and a circuit region located on at least one side of the light-transmitting region;
a driving backplane includes a plurality of pixel circuits distributed in an array and a plurality of first reset signal lines, where the pixel circuits include first pixel circuits and a second pixel circuit, the first pixel circuits are located in the main display region and the circuit region, the second pixel circuit is located in the circuit region; the plurality of first reset signal lines extend along a first direction, part of the plurality of first reset signal lines are first-type first reset signal lines, and part of the first reset signal lines are second-type first reset signal lines; the second-type first reset signal line includes a first reset segment and a second reset segment intermittently arranged along the first direction, the first reset segment is located in the main display region, and the second reset segment is located in the circuit region; and
a plurality of light-emitting devices are located on one side of the driving backplane, and includes first light-emitting devices located in the main display region and the circuit region, and a second light-emitting device located in the light-transmitting region; the first light-emitting devices are connected to the first pixel circuits, and the second light-emitting device is connected to the second pixel circuit through a connecting line;
where the first reset segment is connected to part of the first pixel circuits in the main display region, and the first reset segment is configured to provide a first reset signal to the first pixel circuits in the main display region; the second reset segment is connected to the second pixel circuit and the first pixel circuits in the circuit region, and the second reset segment is configured to provide a second reset signal to the second pixel circuit and the first pixel circuits in the circuit region.

In an exemplary embodiment of this disclosure, the driving backplane further includes:
a first reset bus, located in the peripheral region;
a second reset bus, located in the peripheral region and spaced apart from the first reset bus, where the second reset bus is connected to the first reset segment in the main display region; and
a first reset connection line, extending from the peripheral region to the display region along a second direction, where the first reset connection line connects the first reset bus with the second reset segment;
where the first direction intersects with the second direction.

In an exemplary embodiment of this disclosure, in the first direction, a gap region extending along the second direction is provided between the main display region and the circuit region, and the first reset connection line is located within the gap region.

In an exemplary embodiment of this disclosure, a number of the circuit region in the secondary display region is two, and the two circuit regions are respectively located on both sides of the light-transmitting region along the first direction; two gap regions are respectively provided between the two circuit regions and the main display region;
a number of the first reset connection line is two, the two first reset connection lines are respectively provided in the two gap regions, and the two first reset connection lines are connected to the first reset bus.

In an exemplary embodiment of this disclosure, a number of the secondary display region is two, and a number of the first reset connection line is four; the first reset connection lines are respectively provided in each of the gap regions, and the four first reset connection lines are all connected to the first reset bus.

In an exemplary embodiment of this disclosure, with respect to two first reset connection lines located on both sides of one of the secondary display regions, first ends of the two first reset connection lines are connected to the first reset bus, and second ends of the two first reset connection lines are connected through a connecting wire extending along the first direction.

In an exemplary embodiment of this disclosure, the peripheral region includes a fan-out region extending in a direction away from the display region;
the first reset bus includes a first bus segment, a second bus segment and a third bus segment, where the first bus segment and the second bus segment are located on both sides of the display region and extend to the fan-out region, the third bus segment is located on a side of the display region away from the fan-out region and connects the first bus segment with the second bus segment, and the first reset connection line is connected to the third bus segment,
the second reset bus is located on both sides of the display region and extends to the fan-out region, the second reset bus is disconnected on a side of the display region away from the fan-out region, and the first reset connection line passes through a disconnected position of the second reset bus.

In an exemplary embodiment of this disclosure, a number of the secondary display region is multiple, and the multiple secondary display regions are spaced apart along the first direction;
the main display region between two adjacent secondary display regions is provided with a second reset connection line extending along the second direction; at least one of the first-type first reset signal line is connected to the first reset segment between the two adjacent secondary display regions through the second reset connection line.

In an exemplary embodiment of this disclosure, a number of the second reset connection line between the two secondary display regions is two, and the two second reset connection lines are spaced apart along the first direction; the first reset segment between the two adjacent secondary display regions are connected through the two second reset connection lines.

In an exemplary embodiment of this disclosure, two first reset segments of a single first reset signal line separated by one of the secondary display regions in the first direction are connected through a lead; at least part of the lead is located on a side, close to the fan-out region, of the first reset segment connected to the lead, or at least part of the lead is located on a side, away from the fan-out region, of the first reset segment connected to the lead.

In an exemplary embodiment of this disclosure, the first reset signal line includes a plurality of wiring units distributed along the first direction and a connection unit connected to two adjacent wiring units, and the connection unit and the wiring units are located on different layers;
both the first reset segment and the second reset segment include the plurality of wiring units and the connection unit;
in the first reset signal line having the first reset segment and the second reset segment, the connection unit is intermittently provided in the gap region, one end of the connection unit is connected to one of the wiring units in the first reset segment, and another end of the connection unit is connected to one of the wiring units in the second reset segment;
the first reset connection line intersects with the intermittently provided connection unit.

In an exemplary embodiment of this disclosure, the wiring units, the first reset connection line and the second reset connection line are arranged on a same layer, and are located on a side of the connection unit close to the light-emitting devices.

In an exemplary embodiment of this disclosure, the first reset connection line and the second reset connection line are arranged on a same layer, and are located on a side of the wiring units away from the connection unit.

In an exemplary embodiment of this disclosure, the second reset connection line is disposed across and connected to part of the connection unit.

In an exemplary embodiment of this disclosure, the pixel circuits are divided into a plurality of circuit groups distributed in an array; one of the circuit groups includes a plurality of circuit units distributed along the first direction; and one of the circuit units includes two of the pixel circuits distributed along the first direction;
in the first direction, a distance between two adjacent circuit groups is greater than a distance between two adjacent pixel circuits; two pixel circuits of a single circuit unit are symmetrically arranged relative to a straight line extending along the second direction;
the gap region is a partial region between two adjacent circuit groups.

In an exemplary embodiment of this disclosure, the pixel circuit includes a first reset transistor;
in the circuit region, the second reset segment is connected to the light-emitting device through the first reset transistor;
in the main display region, the first reset segment is connected to the light-emitting device through the first reset transistor.

In an exemplary embodiment of this disclosure, the display panel further includes:
a connecting layer, provided between the driving backplane and the light-emitting devices, and including the connecting line, where the connecting line extends from the circuit region to the light-transmitting region, and at least one of the second light-emitting device is connected to at least one of the second pixel circuit through at least one of the connecting line.

According to an aspect of this disclosure, a display device is provided and includes:
the display panel according to any embodiments described above; and
a photosensitive element, located on a side of the driving backplane away from the plurality of light-emitting devices, where an orthographic projection of the photosensitive element on the driving backplane at least partially overlaps with an orthographic projection of the light-transmitting region on the driving backplane.

It should be understood that the foregoing general description and the following detailed description are exemplary and explanatory only, and do not limit this disclosure.

### BRIEF DESCRIPTION OF THE DRAWINGS

The accompanying drawings, which are incorporated in and constitute a part of this specification, illustrate embodiments consistent with the disclosure and together with the description serve to explain the principles of the disclosure. The drawings in the following description are only some embodiments of this disclosure, and those skilled in the art can obtain other drawings according to these drawings without creative efforts.

FIG. 1 is a top view of a display panel according to some embodiments of this disclosure.

FIG. 2 is a schematic diagram showing the partial distribution of pixel circuits and light-emitting devices in a display panel according to some embodiments of this disclosure.

FIG. 3 is a schematic diagram of a pixel circuit in a display panel according to some embodiments of this disclosure.

FIG. 4 is a schematic cross-segmental view of a display panel according to some embodiments of this disclosure.

FIG. 5 is a partial view of part A in FIG. 1.

FIG. 6 is a schematic diagram of the first semiconductor layer and the first gate layer in FIG. 5.

FIG. 7 is a schematic diagram of the first semiconductor layer to the second gate electrode layer in FIG. 5.

FIG. 8 is a schematic diagram of the first semiconductor layer to the third gate layer in FIG. 5.

FIG. 9 is a schematic diagram of the first semiconductor layer to the first source-drain layer in FIG. 5.

FIG. 10 to FIG. 16 are partial schematic views of some film layers in FIG. 5, respectively.

FIG. 17 is a partial view of part B in FIG. 5.

FIG. 18 to FIG. 20 are partial schematic views of some film layers in FIG. 17.

FIG. 21 is a top view of a display panel according to some other embodiments of this disclosure.

FIG. 22 is a top view of a display panel according to some other embodiments of this disclosure.

FIG. 23 is a top view of a display panel according to some other embodiments of this disclosure.

### DETAILED DESCRIPTION

Exemplary embodiments will now be described more fully with reference to the accompanying drawings. However, the exemplary embodiments are capable of being implemented in various forms and should not be construed as limited to the embodiments set forth herein. Rather, these embodiments are provided so that this disclosure will be thorough and complete and will fully convey the concepts of the exemplary embodiments to those skilled in the art. Like reference numerals in the drawings indicate the same or similar structures, and detailed descriptions thereof will be omitted. Furthermore, the drawings are merely schematic illustrations of the present disclosure and are not necessarily drawn to scale.

The terms “a”, “an”, “the”, “the” and “at least one” are used to mean that there are one or more elements/components/etc.; the terms “including” and “having” are used to mean open-ended inclusion and mean that there may be additional elements/components/etc. in addition to the listed elements/components/etc.; the terms “first”, “second” and “third” and the like are used merely as labels and are not limiting on the number of objects thereof.

Herein, the first direction may be represented by the row direction X, the second direction may be represented by the column direction Y, and the row direction X and the column direction Y are only two mutually intersecting directions, for example, the two directions may be perpendicular to each other. In the drawings of the present disclosure, the row direction X may be a horizontal direction, and the column direction Y may be a vertical direction, but it is not limited thereto. If the display panel rotates, the actual orientations of the row direction X and the column direction Y may change.

The “overlapping” between the feature A and the feature B herein means that orthographic projections of the feature A and the feature B on the substrate at least partially overlap with each other.

The “same/single layer” of the feature A and the feature B herein means that the feature A and the feature B may be formed simultaneously, and the feature A and the feature B are discontinuous or continuous different regions in a same film layer, and the feature A and the feature B are not separated by other film layers in a direction perpendicular to the substrate. By “different layers” is meant that the features A and B are spaced apart in a direction perpendicular to the substrate, and the two are separated by other film layer(s).

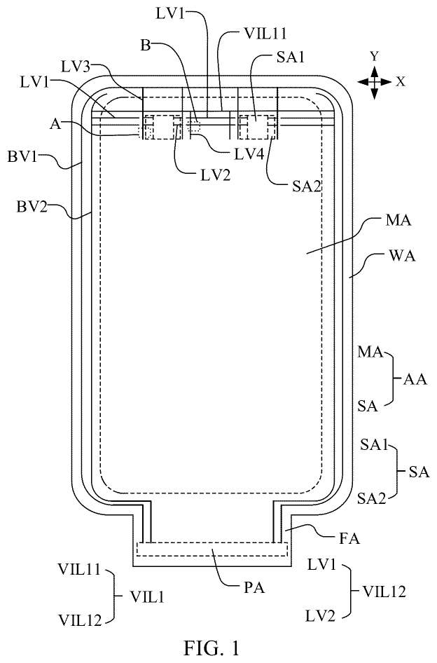

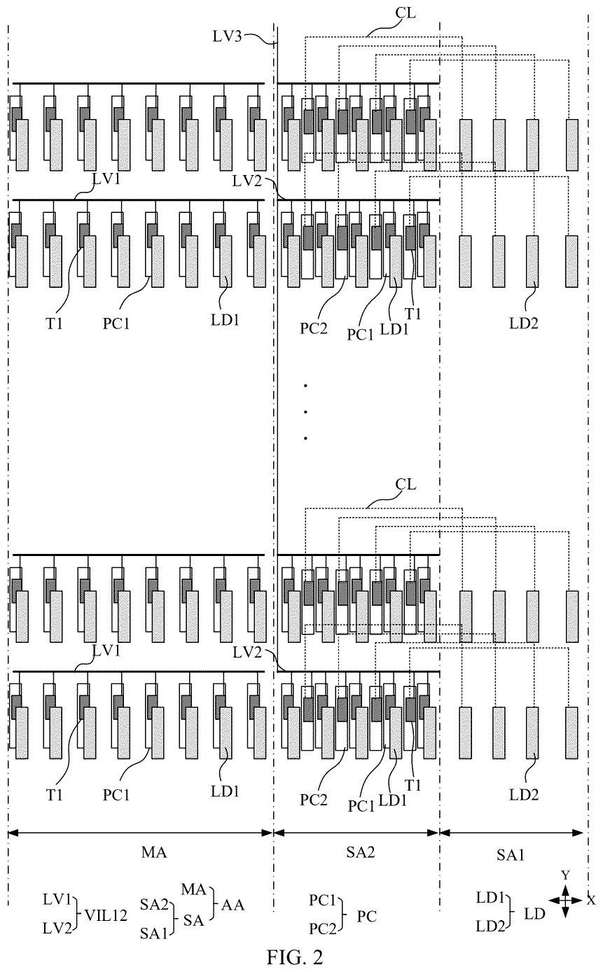

Embodiments of the present disclosure provide a display panel, as shown in FIG. 1 and FIG. 2, the display panel may have a display region AA and a peripheral region WA located outside the display region AA, and the peripheral region WA may be a continuous or discontinuous annular area surrounding the display region AA, that is, the peripheral region WA is disposed at least partially surrounding the display region AA, and the shape of the peripheral region WA is not specifically limited herein.

The peripheral region WA may include a fan-out region FA extending in a direction away from the display region AA, and the display region AA and the fan-out region FA may be distributed along the column direction Y. The fan-out region FA has a bonding part PA, and the bonding part PA may be provided with a plurality of bonding pads. A flexible circuit board may be bonded to through the bonding pads, so that the display region AA of the display panel may be controlled to emit light through a control circuit board bonded to the flexible circuit board, thereby displaying an image.

The display region AA may include a main display region MA and a secondary display region SA, where the main display region MA is located outside the secondary display region SA. In the row direction X, the main display region MA may be located on at least one side of the secondary display region SA. For example, the main display region MA may surround the secondary display region SA, or a boundary of the main display region MA partially coincides with a boundary of the secondary display region SA.

The secondary display region SA may include a light-transmitting region SA1 and a circuit region SA2 outside the light-transmitting region SA1, and the circuit region SA2 is located on at least one side of the light-transmitting region SA1 in the row direction X.Light can be emitted from both the light-transmitting region SA1 and the circuit region SA2, but the light transmittance of the light-transmitting region SA1 is greater than that of the circuit region SA2, so as to realize under-screen imaging. The shape of the light-transmitting region SA1 may be a circle, an ellipse, a polygon such as a rectangle, or other regular or irregular shapes, which is not specifically limited herein. At least part of regions of the circuit region SA2 and the light-transmitting region SA1 may be distributed along the row direction X. For example, one light-transmitting region SA1 and two circuit regions SA2 are provided in one secondary display region SA, and the two circuit regions SA2 are respectively located on two sides of the light-transmitting region SA1 along the row direction X, and may be symmetrically arranged with respect to a straight line passing through the center of the light-transmitting region SA1 along the column direction Y.

As shown in FIG. 2 and FIG. 4, the display panel may include a driving backplane BP and a plurality of light-emitting devices LD disposed on one side of the driving backplane BP, and the driving backplane BP is provided with a driving circuit for driving the light-emitting devices LD to emit light. The driving circuit may include a pixel circuit PC located in the display region AA and a peripheral circuit located in the peripheral region WA.

In some embodiments, there are a plurality of pixel circuits PC, and the pixel circuits PC are distributed in a plurality of rows and a plurality of columns in an array along the row direction X and the column direction Y, and one pixel circuit PC may be connected to one light-emitting device LD. Alternatively, there may also be a situation where one pixel circuit PC is connected to multiple light-emitting devices LD. This disclosure only takes the one-to-one connection between the pixel circuit PC and the light-emitting device LD as an example for description. The pixel circuit PC may be distributed in the circuit regions SA2 of the main display region and the secondary display region SA, and the pixel circuit PC is not disposed in the light-transmitting region SA1, so as to improve the light transmittance of the light-transmitting region SA1. Specifically, each pixel circuit PC may be divided into a first pixel circuit PC1 and a second pixel circuit PC2, where the first pixel circuit PC1 is distributed in the main display region MA and the circuit region SA2, and the second pixel circuit PC2 is located in the circuit region SA2. In other words, the circuit region SA2 is provided with both the first pixel circuit PC1 and the second pixel circuit PC2, while the main display region MA is only provided with the first pixel circuit PC1.

The pixel circuit PC may include a plurality of transistors and capacitors, which may be pixel circuits such as 3T1C, 7T1C, and 8T1C, where nTmC indicates that one pixel circuit PC includes n transistors (denoted by the letter “T”) and m capacitors (denoted by the letter “C”).

The peripheral circuit may be connected to the pixel circuit PC and the light-emitting device LD, and may control the current passing through the light-emitting device LD through the pixel circuit PC, thereby controlling the brightness of the light-emitting device LD. The peripheral circuit may include a gate driving circuit and a light emission control circuit, etc. Alternatively, it may also include other circuits, and the specific structure of the peripheral circuit is not particularly limited herein.

Each light-emitting device LD may be disposed on one side of the driving backplane BP and located in the display region AA, and the light-emitting devices LD are disposed in the light-transmitting region SA1 and the circuit region SA2 of the main display region MA and the secondary display region SA, so that light can be emitted from the entire display region AA. Meanwhile, the light-emitting device LD may include a first electrode ANO, a light-emitting layer EL and a second electrode CAT stacked in a direction away from the driving backplane BP. The light-emitting device LD may be an OLED (organic light emitting diode), or may be a Micro LED (micro light emitting diode) or a Mini LED (sub-millimeter light emitting diode), or may be a light-emitting device such as a QLED (quantum dot diode).

As shown in FIG. 4, the first electrode ANO may be disposed on one side of the driving backplane BP and distributed in an array. The light-emitting layer EL may include a hole injection layer, a hole transport layer, a light-emitting material layer, an electron transport layer, and an electron injection layer stacked in a direction away from the driving backplane BP. Each light-emitting device LD may share the second electrode CAT, that is, the second electrode CAT may be a continuous whole layer structure, and the second electrode CAT may extend to the peripheral region and may be configured to receive a second power signal VSS. The first electrode ANO is distributed in an array and connected to the pixel circuit PC, so as to ensure that each light-emitting device LD may emit light independently. In addition, in order to define the light emitting range of the light-emitting device LD and prevent crosstalk, a pixel definition layer PDL may be disposed on the surface where the first electrode ANO is disposed, and may be provided with an opening exposing each first electrode ANO, where the light-emitting layer EL is stacked with the first electrode ANO in the opening.

Each of the light-emitting devices LD may share at least the light-emitting material layer, so that the light emitting colors of the light-emitting devices LD are the same. Accordingly, in order to achieve color display, a color filter layer may be disposed on a side of the light-emitting device LD away from the driving backplane BP, and color display can be achieved through filter portions corresponding to the light-emitting devices LD in the color filter layer. Alternatively, the light-emitting material layer of each light-emitting device LD may also be independent, so that the light-emitting device LD may directly emit monochromatic light, and the light-emitting colors of different light-emitting devices LD may be different, thereby achieving color display.

As shown in FIG. 2, based on the above division of the pixel circuit PC, the light-emitting devices may be correspondingly divided into a first light-emitting device LD1 and a second light-emitting device LD2, where the first light-emitting device LD1 is distributed in the main display region MA and the circuit region SA2, and the second light-emitting device LD2 is distributed in the light-transmitting region SA1. Moreover, in order to drive each light-emitting device LD, in the main display region MA and the circuit region SA2, the first light-emitting device LD1 may be connected with the first pixel circuit PC1, so as to emit light under the driving of the first pixel circuit PC1; and the second light-emitting device LD2 may be connected with the second pixel circuit PC2 through the connecting line CL, where the connecting line CL may extend from the light-transmitting region SA1 to the circuit region SA2.

For example, as shown in FIG. 2 and FIG. 4, in some embodiments of the present disclosure, the display panel may include a transfer layer BL, which may be disposed between the driving backplane BP and the light-emitting device LD, and includes a plurality of connecting lines CL extending from the circuit region SA2 to the light-transmitting region SA1, and at least one second light-emitting device LD2 is connected to at least one second pixel circuit PC2 through at least one connecting line CL. For example, one second light-emitting device LD2 is connected to one second pixel circuit PC2 through one connecting line CL, so that one second pixel circuit PC2 only drives one second light-emitting device LD2. Alternatively, one second light-emitting device LD2 is connected to multiple second pixel circuits PC2 through multiple connecting lines CL, so that multiple second pixel circuits PC2 can drive the same second light-emitting device LD2. Alternatively, multiple second light-emitting devices LD2 are connected to the same second pixel circuit PC2 through multiple connecting lines CL, so that one second pixel circuit PC2 can drive multiple second light-emitting devices LD2.

The connecting line CL may be made of a transparent conductive material, which may include a transparent conductive material such as indium tin oxide (ITO), so as to reduce the influence on the light transmittance of the light-transmitting region SA1. In addition, the connecting lines CL connected to the second light-emitting devices LD2 may be located in the same layer or may be distributed in multiple layers. For example, the transfer layer BL may include a plurality of wiring layers and planarization layers alternately distributed in a direction away from the driving backplane BP, and the specific numbers thereof are not limited herein, so that each wiring layer is covered by one planarization layer, and each wiring layer may be provided with a part of the connecting lines CL, so as to increase the wiring space.

In addition, the display panel may further include an encapsulation layer covering each light-emitting device LD, which may adopt a thin film encapsulation manner. For example, the encapsulation layer includes a first inorganic layer, an organic layer and a second inorganic layer, where the first inorganic layer may cover each light-emitting device. In other words, the first inorganic layer may cover a surface of the second electrode CAT away from the driving backplane BP. A material of the first inorganic layer may include an inorganic insulating material such as silicon nitride and silicon oxide. The organic layer may be disposed on a surface of the first inorganic layer away from the driving back plate BP, and a boundary of the organic layer may be limited to an inner side of the boundary of the first inorganic layer by a barrier dam located in the peripheral region WA.

The second inorganic layer may cover the organic layer and the first inorganic layer not covered by the organic layer, so that water and oxygen intrusion can be blocked by the second inorganic layer, and planarization can be achieved by the organic layer with fluidity (during manufacturing). A material of the second inorganic layer may include an inorganic insulating material such as silicon nitride and silicon oxide.

In addition, the display panel may further include other film layers such as a touch layer and a transparent cover plate disposed on a side of the encapsulation layer away from the driving backplane BP, where the transparent cover plate may be located on a side of the touch layer away from the driving backplane BP.

Taking the touch layer using the mutual-capacitance touch structure as an example, the touch layer may include a plurality of first touch electrodes and a plurality of second touch electrodes, where the first touch electrodes may be spaced apart along the row direction X, each first touch electrode may include a plurality of first electrode blocks spaced apart along the column direction Y and a transfer bridge connecting two adjacent first electrode blocks; and the second touch electrodes may be spaced apart along the column direction Y, each second touch electrode includes a plurality of second electrode blocks connected in series along the row direction X and a transfer bridge intersects with and is insulated from the second touch electrode. One of the first touch electrode and the second touch electrode may be used as a transmitting electrode, and the other is used as a receiving electrode, and both are connected to a peripheral touch driving circuit.

The following describes a pixel circuit PC with a 7T1C structure as an example.

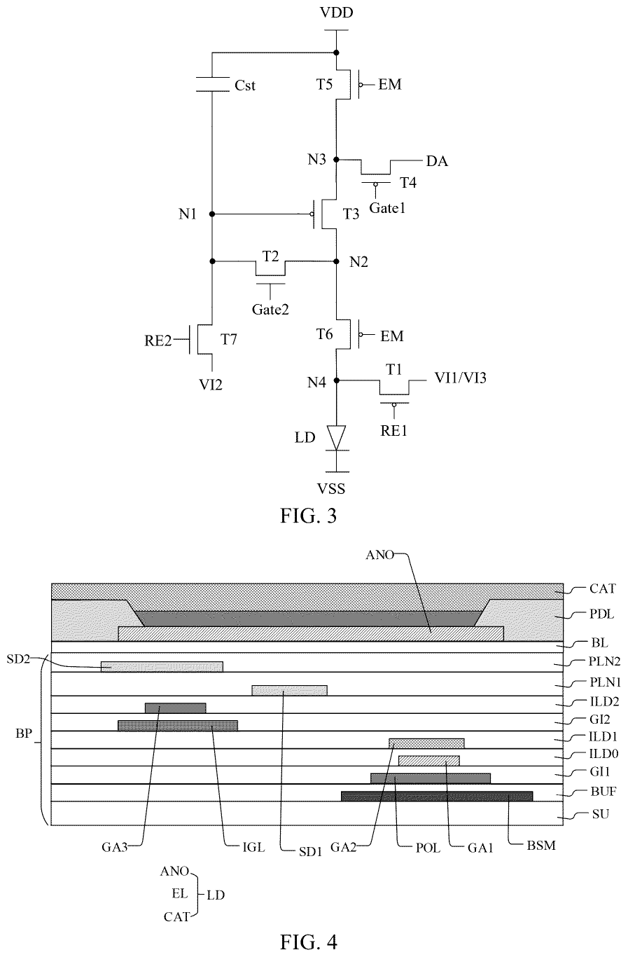

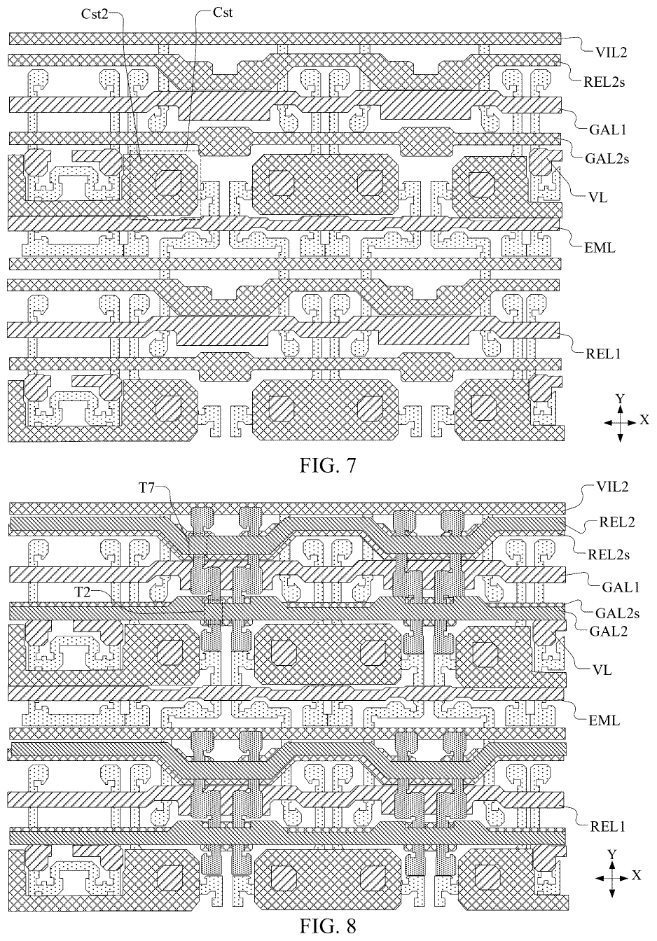

As shown in FIG. 3 to FIG. 9, the transistors of the pixel circuit PC may include a first reset transistor T1, a compensation transistor T2, a driving transistor T3, a writing transistor T4, a first light emission control transistor T5, a second light emission control transistor T6, a second reset transistor T7, and a storage capacitor Cst, where each transistor includes a gate, a first electrode and a second electrode, and the first and second electrodes can be turned on or off by applying a control signal on the gate. The storage capacitor Cst may include a first plate and a second plate that overlap.

As shown in FIG. 3, a gate of the first light emission control transistor T5 is configured to input a light emission control signal EM, a first electrode thereof is configured to input a first power signal VDD, and a second electrode thereof is connected to a first electrode of the driving transistor T3. A gate of the driving transistor T3 is connected to a first node N1, a second electrode of the driving transistor T3 and a first electrode of the second light emission control transistor T6 are connected to a second node N2, a second electrode of the second light emission control transistor T6 is connected to a first electrode ANO of the light-emitting device LD, and a gate of the second light emission control transistor T6 is configured to input the light emission control signal EM.

A gate of the first reset transistor T1 is configured to input a first reset control signal RE1, a first electrode of the first reset transistor T1 is configured to input a first reset signal VI1, that is, the first-type reset signal, and the second electrode of the second light emission control transistor T6 and the first electrode ANO are connected to a fourth node N4.

A gate of the writing transistor T4 is configured to input a first scanning signal Gate1, a first electrode thereof is configured to input a data signal DA, and a second electrode of the writing transistor T4, a first electrode of the driving transistor T3, and a second electrode of the first light emission control transistor T5 are connected to a third node N3.

A gate of the compensation transistor T2 is configured to input a second scan signal Gate2, a first electrode thereof and the driving transistor T3 are connected to the second node N2, and a second electrode thereof is connected to the first node N1.

A gate of the second reset transistor T7 is configured to input a second reset control signal RE2, a first electrode thereof is configured to input a second reset signal VI2, and a second electrode thereof is connected to the first node N1.

The first electrode plate of the storage capacitor Cst is configured to input the first power signal VDD, and the second electrode plate is connected to the first node N1.

The working principle of the pixel circuit PC is described below.

In the reset phase t1, the second reset transistor T7 may be turned on by the second reset control signal RE2, and the first reset signal VI2 is written to the first node N1. Meanwhile, the first reset transistor T1 is turned on by the first reset control signal RE1, and the first reset signal VI1 is written to the fourth node N4. Thus, the gate of the driving transistor T3 and the light-emitting device LD can be reset.

In the writing phase t2, the writing transistor T4 and the compensation transistor T2 are turned on by the first scanning signal Gate1 and the second scanning signal Gate2, and the data signal DA is written to the first node through the third node N3 and the second node N2 until the potential reaches Vdata+vth, where Vdata is the voltage of the data signal DA, and Vth is the threshold voltage of the driving transistor T3. The first scan signal Gate1 and the second scan signal Gate2 may be the same signal or two synchronized signals. In addition, the first scan signal Gate1 and the second scan signal Gate2 may be high-frequency signals, which is beneficial to reduce the load of the source signal of the driving transistor T3.

In the light-emitting stage t3, the first light emission control transistor T5 and the second light emission control transistor T6 are turned on by the light emission control signal EM, the driving transistor T3 is turned on under the action of the voltage Vdata+Vth stored in the storage capacitor Cst and the first power signal VDD, and the light-emitting device LD emits light under the action of the first power signal VDD and the second power signal VSS. In this process, the first electrode of the driving transistor T3 serves as a source electrode, and the second electrode serves as a drain electrode.

The current output by the driving transistor T3 satisfies the following formula:

$$I = ( μ W Cox / 2 L ) {( Vgs - Vth )}^{2}$$

where I is an output current of the driving transistor T3; μ is a carrier mobility; Cox is a gate capacitance per unit area; W is a channel width of the driving transistor T3; L is a channel length of the driving transistor T3; Vgs is a gate-source voltage difference (a voltage difference between the gate and the source) of the driving transistor T3; and Vth is a threshold voltage of the driving transistor T3.

According to the above formula of the output current of the driving transistor T3, the gate voltage Vdata+Vth and the source voltage VDD of the driving transistor T3 in the pixel circuit PC of the present disclosure are substituted into the above formula to obtain the output current of the driving transistor T3 as: I=(μWCox/2L)(Vdata+Vth−VDD−Vth)². It can be seen that the output current of the pixel circuit PC is unrelated to the threshold voltage Vth of the driving transistor T3 and only related to Vdata, thereby eliminating the influence of the threshold voltage of the driving transistor T3 on the output current thereof, and the output current can be controlled only by the voltage Vdata of the data signal DA, so as to control the brightness of the light-emitting device LD.

Each transistor of the pixel circuit PC may be a polysilicon transistor, that is, a channel of the transistor is polysilicon, for example, a P-type low-temperature polysilicon (LTPS) transistor or an N-type LTPS transistor. Alternatively, a metal oxide transistor may also be used, that is, a channel of the transistor is a metal oxide such as indium gallium zinc oxide. The P-type LTPS transistor may be turned off when a high level is input to the gate thereof, and turned on when a low level signal is input thereto; and the N-type LTPS transistor may be turned off when a low level is input to the gate thereof, and turned on when a high level signal is input thereto. The metal oxide transistor may be an N-type metal oxide transistor, which may be turned on when the gate input is at a high level and turned off when the gate input is at a low level.

In some embodiments of the present disclosure, the above 7TIC pixel circuit may adopt LTPO (LTPS+Oxide) technology. For example, the driving transistor T3, the writing transistor T4, the first reset transistor T1, the first light emission control transistor T5 and the second light emission control transistor T6 may adopt P-type LTPS transistors; and the second reset transistor T7 and the compensation transistor T2 may adopt N-type metal oxide transistors. Since the P-type LTPS transistor has a relatively high carrier mobility, it is beneficial to implement a display panel with high resolution, high reaction speed, high pixel density and high aperture ratio, so as to obtain a relatively high carrier mobility and improve a response speed. Moreover, leakage can be reduced by the N-type metal oxide transistor.

As shown in FIG. 6, based on the above pixel circuit PC using the LTPO technology, in some embodiments of the present disclosure, each pixel circuit PC may be divided into a plurality of circuit groups CM distributed in an array, where one circuit group CM may include a plurality of circuit units CU distributed along the row direction X, and one circuit unit CU may include two pixel circuits PC distributed along the row direction X. Furthermore, in the row direction X, a distance between two adjacent circuit groups CM is greater than a distance between two adjacent pixel circuits PC, and the two pixel circuits PC in the same circuit unit CU may be symmetrically arranged with respect to a straight line extending along the column direction Y, where the symmetrical arrangement herein means that the two pixel circuits PC are completely symmetrical or the transistors of the two pixel circuits PC are symmetrical.

The above signals input to the pixel circuit PC can all be transmitted through wires, and the wires for transmitting the above signals will be described below.

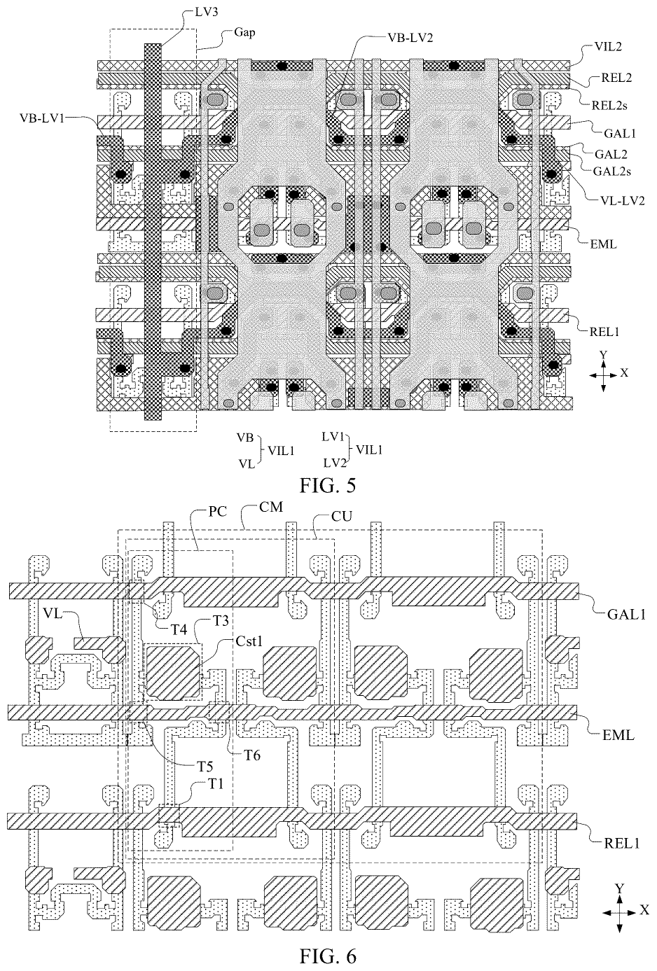

As shown in FIG. 5 to FIG. 9, the driving backplane BP may include a plurality of row wires extending at least partially along the row direction X, where any row wire may be connected to one row of pixel circuits PC. These row wires may include a first reset control line REL1, a first reset signal line VIL1, a second reset control line REL2, a second reset signal line VIL2, a first scan line GAL1, a second scan line GAL2 and a light emission control line EML.

For one pixel circuit PC, the first reset control line REL1 may be connected to the gate of the first reset transistor T1 for transmitting the first reset control signal RE1. The first reset signal line VIL1 may be connected to the first electrode of the first reset transistor T1 for transmitting the first reset signal VI1 to the first electrode ANO of the light-emitting device LD.

In some embodiments of the present disclosure, the first reset signal line VIL1 may include a plurality of wiring units VB distributed along the row direction X and a connection unit VL connected to two adjacent wiring units VB, and the connection unit VL and the wiring units VB are located in different layers, so that other wires in the same layer as the wiring units VB may pass through between the two adjacent wiring units VB. Further, the wiring units VB may be located within the range of the above-mentioned circuit group CM, and the connection unit VL is located between two adjacent circuit groups CM. In other words, two adjacent wiring units VB cross a region between two adjacent circuit groups CM through the connection unit VL.

The second reset control line REL2 may be connected to the gate of the second reset transistor T7 for transmitting the second reset control signal RE2. The second reset signal line VIL2 is connected to the first electrode of the second reset transistor T7 for transmitting the second reset signal VI2.

The first scan line GAL1 may be connected to the gate of the writing transistor T4 for transmitting the first scan signal Gate1. The second scan line GAL2 may be connected to the gate of the compensation transistor T2 for transmitting the second scan signal Gate2.

The light emission control line EML may be connected to the gate of the first light emission control transistor T5 and the gate of the second light emission control transistor T6, and configured to transmit a light emission control signal.

In addition to the row wires described above, the driving backplane BP further includes a column wire extending along the column direction Y, including a data line DAL and a power line VDL, with the data line DAL being connected to the first electrode of the writing transistor T4 of each pixel circuit PC in a column of pixel circuits PC, and being configured to transmit a data signal DA. The power line VDL may be connected to the second electrode plate Cst2 of each pixel circuit PC in a column of pixel circuits PC and the first electrode of the first light emission control transistor T5 for transmitting the first power signal VDD.

Each film layer of the driving backplane BP is described in detail below based on the 7TIC pixel circuit.

As shown in FIG. 4, in some embodiments of the present disclosure, the driving backplane BP may include a substrate SU, a first semiconductor layer POL, a first gate insulating layer GI1, a first gate layer GA1, a first insulating layer ILD0, a second gate layer GA2, a second insulating layer ILD1, a second semiconductor layer IGL, a second gate insulating layer GI2, a third gate layer GA3, a third insulating layer ILD2, a first source-drain layer SD1, a first planarization layer PLN1, a second source-drain layer SD2, and a second planarization layer PLN2.

The substrate SU may be made of a flexible transparent material such as polyimide (PI) or a hard transparent material such as glass, and the substrate SU may be a multi-layer or single-layer structure.

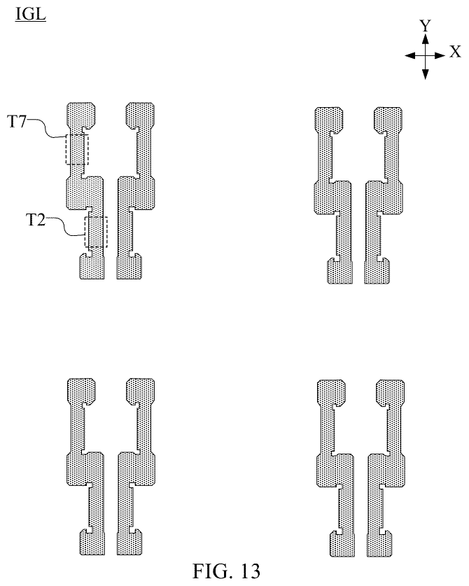

As shown in FIG. 10, the first semiconductor layer POL may be disposed on a side of the substrate SU, and includes channels of the driving transistor T3, the writing transistor T4, the first reset transistor T1, the first light emission control transistor T5 and the second light emission control transistor T6 in the pixel circuit PC. The material of the first semiconductor layer POL may be polysilicon.

The first gate insulating layer GI1 may cover the first semiconductor layer POL, and a material of the first gate insulating layer GI1 may be an insulating material such as silicon nitride or silicon oxide.

As shown in FIG. 11, the first gate layer GA1 may be disposed on a surface of the first gate insulating layer GI1 away from the substrate SU, and includes a first reset control line REL1, a light emission control line EML, a first scan line GAL1, and a first electrode plate Cst1 of the storage capacitor Cst.

The first electrode plate Cst1 overlaps with a partial region of the first semiconductor layer POL, where the first semiconductor layer POL at the overlapping position serves as a channel of the driving transistor T3, and the first electrode plate Cst1 is reused as a gate of the driving transistor T3. The first reset control line REL1 overlaps with a partial region of the first semiconductor layer POL, where the first semiconductor layer POL at the overlapping position serves as a channel of the first reset transistor T1, and the first reset control line REL1 at the overlapping position serves as a gate of the first reset transistor T1. The first scan line GAL1 overlaps with a partial region of the first semiconductor layer POL, where the first semiconductor layer POL at the overlapping position serves as a channel of the writing transistor T4, and the first scan line GAL1 at the overlapping position serves as a gate of the writing transistor T4. The light emission control line EML overlaps with a partial region of the first semiconductor layer POL, where the first semiconductor layer POL at the overlapping position serves as channels of the first light emission control transistor T5 and the second light emission control transistor T6, and the light emission control line EML at the overlapping position serves as gates of the first light emission control transistor T5 and the second light emission control transistor T6.

In addition, the connection unit VL of the first reset signal line VIL1 may also be located in the first gate layer GA1.

The first insulating layer ILD0 may cover the first gate layer GA1, and may be made of an insulating material such as silicon nitride or silicon oxide.

As shown in FIG. 12, the second gate layer GA2 may be disposed on a surface of the first insulating layer ILD0 away from the substrate SU, and include a second reset signal line VIL2 and a second electrode plate Cst2, where the second electrode plate Cst2 overlaps with the first electrode plate Cst1 to form the storage capacitor Cst.

The second insulating layer ILD may cover the second gate layer GA2, may be a single-layer or multi-layer structure, and may be made of an insulating material such as silicon nitride, silicon oxide, or the like. For example, the second insulating layer ILD1 may include a dielectric layer and a buffer layer sequentially stacked in a direction away from the substrate SU.

As shown in FIG. 13, the second semiconductor layer IGL may be disposed on a surface of the second insulating layer ILD1 away from the substrate SU, and includes channels of the second reset transistor T7 and the compensation transistor T2.

The second gate insulating layer GI2 may cover the second semiconductor layer IGL, and may be made of an insulating material such as silicon nitride or silicon oxide.

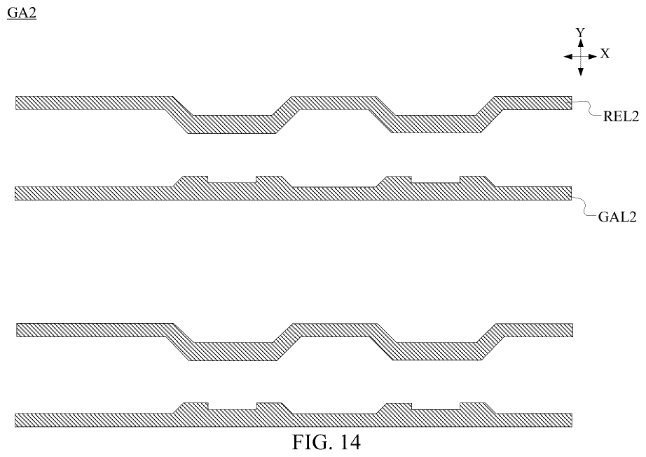

As shown in FIG. 14, the third gate layer GA3 may be disposed on a surface of the second gate insulating layer GI2 away from the substrate SU, includes a second reset control line REL2 and a second scan line GAL2, and overlaps with at least a partial region of the second semiconductor layer IGL.

The third insulating layer ILD2 may cover the third gate layer GA3, may be a single-layer or multi-layer structure, and may be made of an inorganic insulating material such as silicon nitride, silicon oxide, or an organic insulating material such as insulating resin.

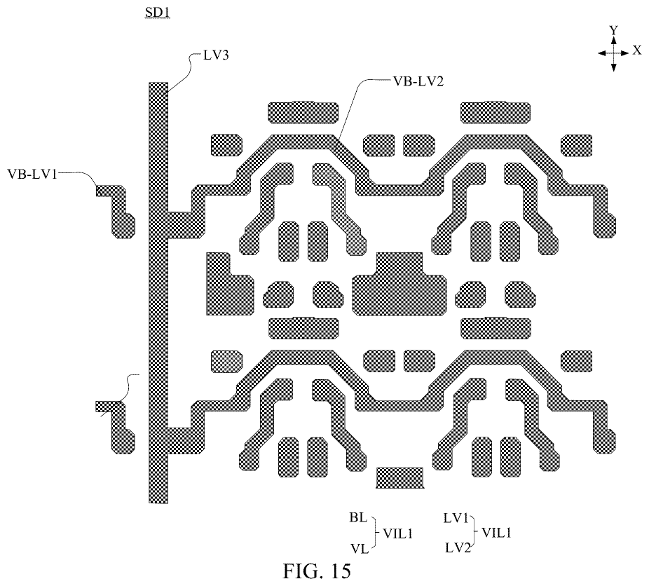

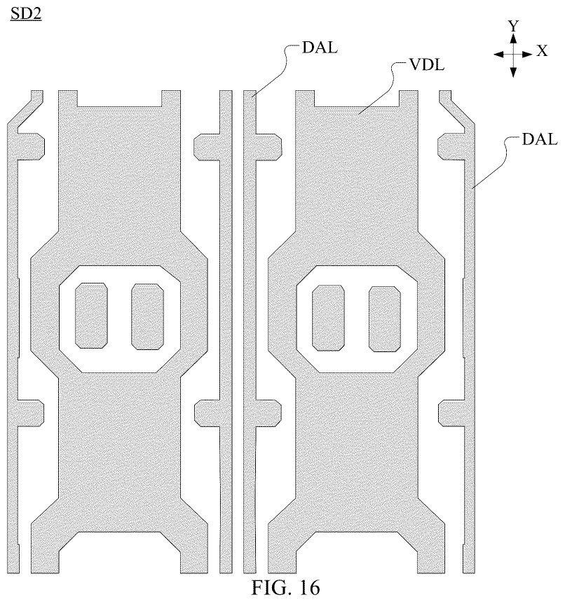

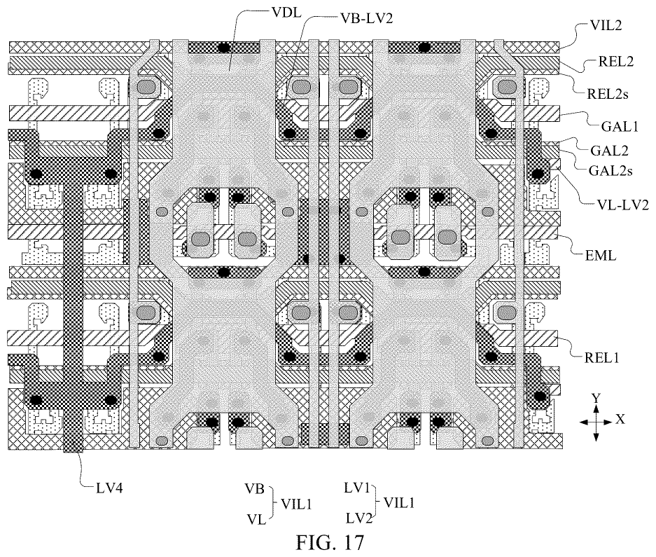

As shown in FIG. 15, the first source-drain layer SD1 may be disposed on a surface of the third insulating layer ILD2 away from the substrate SU, and includes a wiring unit VB.

The first planarization layer PLN1 may cover the first source-drain layer SD1, and a material thereof may be an insulating material such as resin. In addition, a passivation layer may be further included, which may cover the first source-drain layer SD1, and the first planarization layer PLN1 covers the first source-drain layer SD1.

As shown in FIG. 16, the second source-drain layer SD2 may be disposed on a surface of the first planarization layer PLN1 away from the substrate SU, and includes a data line DAL and a power line VDL.

The second planarization layer PLN2 may cover the second source-drain layer SD2, and a material thereof may be an insulating material such as resin. The transfer layer BL may be disposed on a surface of the second planarization layer PLN2 away from the substrate SU.

In addition, further, as shown in FIG. 5 and FIG. 12, the second gate layer GA2 may further include an auxiliary reset line REL2s and an auxiliary scan line GAL2s extending along the row direction X. The auxiliary reset line REL2s may overlap with the second reset control line REL2, and may also overlap with the second semiconductor layer IGL, where the second semiconductor layer IGL corresponding to the overlapping position also serves as a channel of the second reset transistor T7, and the auxiliary reset line REL2s at the overlapping position also serves as a gate of the second reset transistor T7. In addition, the auxiliary reset line REL2s may be connected to the second reset control line REL2 in the display region AA through a contact hole, or may be connected thereto after the auxiliary reset line REL2s and the second reset control line REL2 extend to the peripheral region WA, thereby increasing the gate area of the second reset transistor T7.

The auxiliary scan line GAL2s may overlap with the second scan line GAL2, and may also overlap with the second semiconductor layer IGL, where the second semiconductor layer IGL corresponding to the overlapping position also serves as the channel of the compensation transistor T2, and the auxiliary scan line GAL2s at the overlapping position also serves as the gate of the compensation transistor T2. In addition, the auxiliary scan line GAL2s may be connected to the second scan line GAL2 in the display region AA through a contact hole, or may be connected thereto after the auxiliary scan line GAL2s and the second scan line GAL2 extend to the peripheral region WA, thereby increasing the gate area of the compensation transistor T2.

In addition, as shown in FIG. 4, a light shielding layer BSM may be disposed between the substrate SU and the first semiconductor layer POL, which may be made of a light shielding metal or other materials, and may be in a single-layer or multi-layer structure. At least a partial region of the light shielding layer BSM may overlap with the channel region of at least part of the transistors to shield the light irradiated to the transistors, so that the electrical characteristics of the transistors are stable. The light shielding layer BSM may include a plurality of light shielding units distributed in an array, with each light shielding unit may shield the channel of one driving transistor T3. In addition, the light shielding units may be connected through light shielding lines, so that the light shielding layer BSM is of an integrated structure. A second power signal VSS or a second power signal VDD may be input to the light shielding layer BSM, so that electrostatic shielding can be achieved through the light shielding layer BSM.

Further, as shown in FIG. 4, the light shielding layer BSM may be covered by an insulating buffer layer, and the first semiconductor layer may be disposed on a surface of the buffer layer away from the substrate SU. The buffer layer may be a single-layer or multi-layer structure, and a material thereof may include an insulating material such as silicon nitride or silicon oxide.

In order to save space, as shown in FIG. 5 and FIG. 8, some wires of two adjacent rows of pixel circuits PC may be reused. For example, the first reset control line REL1 connected to the n-th row of pixel circuits PC may be reused as the first scan line GAL1 connected to the (n+1)-th row of pixel circuits PC, where n is a positive integer. In other words, the first reset control line REL1 connected to the n-th row of pixel circuits PC is also the first scan line GAL1 connected to the (n+1)-th row of pixel circuits PC.

Inventors find that, as shown in FIG. 2, since the second pixel circuit PC2 is connected to the second light-emitting device LD2 through the connecting line CL, compared with the first pixel circuit PC1 directly connected to the first light-emitting device LD1, the existence of the connecting line CL will increase the load between the second pixel circuit PC2 and the second light-emitting device LD2 connected thereto. If the first light-emitting device LD1 and the second light-emitting device LD2 are reset by the same reset signal, the reset of the second light-emitting device LD2 lags behind the reset of the first light-emitting device, so that the turn-on of the light-transmitting region SA1 is asynchronous with that of the main display region MA and the circuit region SA2, especially at low gray scales, thereby causing an abnormality in the turn-on.

In order to solve the above-mentioned problem of the turn-on abnormality, as shown in FIG. 3, the inventors propose a new solution. By designing the first reset signal line, the first light-emitting device LD1 and the second light-emitting device LD2 are reset respectively, that is, the first light-emitting device LD1 is reset by using the first reset signal VI1, and the second light-emitting device LD2 is reset by using the third reset signal VI3. By controlling the timing of the third reset signal VI3 and the first reset signal VI1, the turn-on abnormality can be compensated, and the difference between the turn-on time of the light-transmitting region SA1 and the turn-on time of the main display region MA and the circuit region SA2 can be reduced or eliminated, where the third reset signal VI3 is the second-type reset signal. The solution is described in detail below.

As shown in FIG. 1 and FIG. 2, for all pixel circuits PC in the display region AA, each row of the pixel circuits PC may be connected to a reset signal line VIL1, which may be divided into two types. The first-type first reset signal line VIL1 is located outside the secondary display region SA in the column direction Y, that is, the first-type first reset signal line VIL11 and the secondary display region SA are distributed along the column direction Y. The extension direction of the second-type first reset signal line VIL12 intersects with the secondary display region SA, and a partial region of the second-type first reset signal line VIL12 is located within the circuit region SA2 in the secondary display region SA.s

The second-type first reset signal line VIL12 may be divided into a first reset segment LV1 and a second reset segment LV2 that are intermittently disposed along the row direction X, where the first reset segment LV1 is located in the main display region MA, and the second reset segment LV2 is located in the circuit region SA2. As shown in FIG. 5, FIG. 6, FIG. 11 and FIG. 15, both the first reset segment LV1 and the second reset segment LV2 include a plurality of wiring units VB and a connection unit VL.

For the first light-emitting device LD1 in the main display region MA, the first pixel circuit PC1 connected thereto may be connected to the first-type first reset signal line VIL11 and the first reset segment LV1 of the second-type first reset signal line VIL12. In other words, in the main display region MA, the first pixel circuits PC1 distributed along the row direction X with the pixel circuits PC in the secondary display region SA may be connected to the first reset segment LV1 of the second-type first reset signal line VIL12, and the other first pixel circuits PC1 are connected to the first-type first reset signal line VIL11. In this way, the first reset signal VI1 may be transmitted through the first-type first reset signal line VIL11 and the first reset segment LV1 to reset the first light-emitting device LD1 in the main display region AA.

For the light-emitting device LD (the second light-emitting device LD2 and a part of the first light-emitting devices LD1) in the secondary display region SA, the pixel circuits PC (the second pixel circuit PC2 and a part of the first pixel circuits PC1) connected thereto may be connected to the second reset segment LV2 of the second-type first reset signal line VIL12, so that the third reset signal VI3 may be transmitted through the second reset segment LV2, thereby resetting the first electrode ANO of the light-emitting device LD in the secondary display region SA through the third reset signal VI3.

As shown in FIG. 1, in some embodiments of the present disclosure, the driving backplane may further include a first reset bus BV1, a second reset bus BV2 and a first reset connection line LV3.

The first reset bus BV1 may be disposed in the peripheral region WA and connected to the first-type first reset signal line VIL11 and a part of the first reset segments LV1 of the second-type first reset signal line VIL12, that is, connected to a part of respective first reset signal lines VIL1 located in the main display region MA. In addition, the first reset bus BV1 extends to the fan-out region FA and is connected to the bonding part PA to transmit the third reset signal VI3.

The second reset bus BV2 may be provided in the peripheral region, and may be disposed in a same layer as and spaced apart from the first reset bus BV1. The second reset bus BV2 extends to the fan-out region FA and is connected to the bonding part PA to transmit the first reset signal VI1.

The first reset connection line LV3 may extend from the peripheral region WA to the display region AA along the column direction Y, and connect the first reset bus BV1 and the second reset segment LV2, so that the third reset signal VI3 can be transmitted to the second reset segment LV2, and a short circuit with the first reset segment LV1 can be avoided.

As shown in FIG. 1, in some embodiments of the present disclosure, the first reset bus BV1 may include a first bus segment BV11, a second bus segment BV12 and a third bus segment BV13. The first bus segment BV11 and the second bus segment BV12 are located on two sides of the display region AA and extend to the fan-out region FA, and are connected to the bonding part PA. The third bus segment BV13 is located on a side of the display region AA away from the fan-out region FA, and connects the first bus segment BV11 and the second bus segment BV12, thereby forming a “U”-shaped structure surrounding the display region AA. The first reset connection line LV3 may extend to the peripheral region WA along the column direction Y and be connected to the third bus segment BV13.

The second reset bus BV2 is located on both sides of the display region AA, and is disconnected on a side of the display region AA away from the fan-out region FA. The first reset connection line LV3 may pass through a disconnected position of the second reset bus BV2, without overlapping with the second reset bus BV2. If the first reset bus BV1 and the first reset connection line LV3 are disposed in the same layer and provided in an integrated structure, then short circuit can be avoided at the disconnected position of the second reset bus BV2. Alternatively, if the second reset bus BV2 and the first reset connection line LV3 are located in different layers, the first reset connection line LV3 may intersect with the second reset bus BV2.

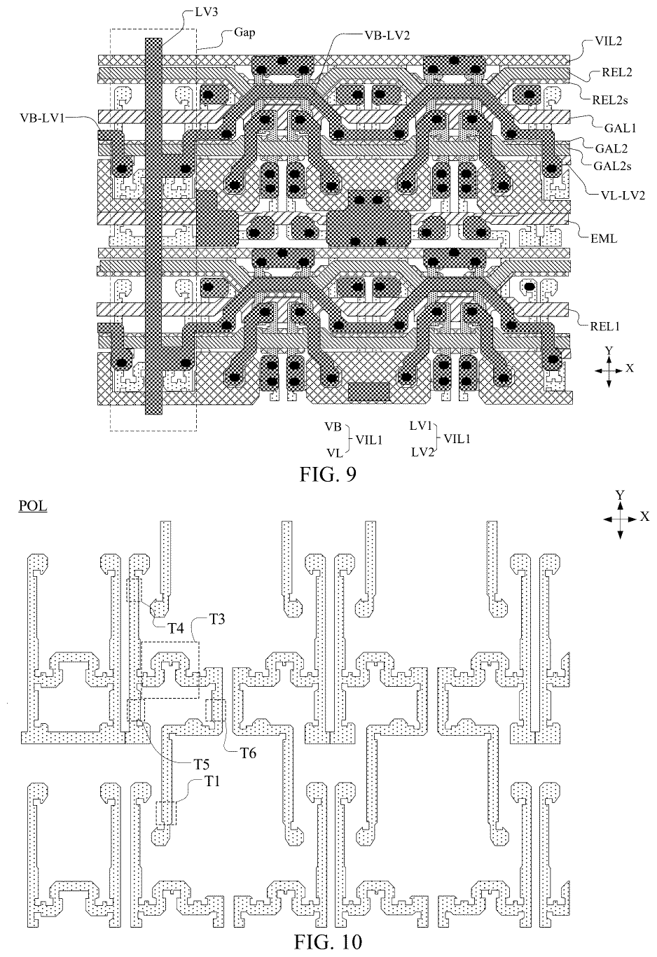

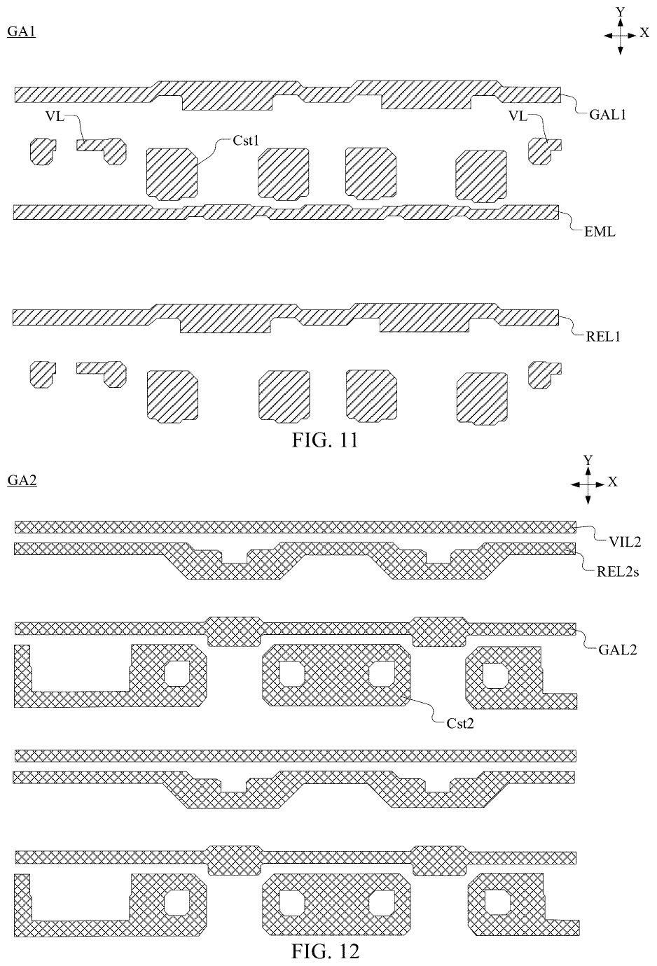

Further, as shown in FIG. 5 and FIG. 9, in some embodiments of the present disclosure, in the row direction X, there may be a gap region Gap extending along the column direction Y between the main display region MA and the circuit region SA2. The gap region Gap may be one of respective regions between two adjacent circuit groups CM, and may only be a region between one circuit group CM, in the circuit region SA2, closest to the main display region MA and one circuit group CM, in the main display region MA, closest to the circuit region SA2. The first reset connection line LV3 may be located in the gap region Gap, so that an end of the second reset segment LV2 may be connected to the first reset connection line LV3. The first reset connection line LV3 may be disposed in the same layer as each wiring unit VB. For example, the first reset connection line LV3 and the wiring unit VB are both located in the first source-drain layer SD1, and are connected to the second reset segment LV2 in an integrated manner.

In addition, as shown in FIG. 5 and FIG. 9, the first reset connection line LV3 may intersect with the connection unit VL in the gap region Gap, and the connection unit VL is intermittently arranged, that is, divided into at least two disconnected portions in the row direction X, so that the first reset segment LV1 and the second reset segment LV2 are disconnected, and the first reset connection line LV3 can be prevented from being connected to the first reset segment LV1. Specifically, in a first reset signal line VIL1 having a first reset segment LV1 and a second reset segment LV2, a connection unit VL is intermittently disposed in the gap region, with one end of the connection unit VL being connected to a wiring unit VB of the first reset segment LV1 through a contact hole, and the other end thereof being connected to a wiring unit VB of the second reset segment LV2 through a contact hole. The intermittently arranged connection unit VL herein can also be completely omitted, as long as the first reset connection line LV3 can be prevented from being connected with the first reset segment LV1. The intermittent connection unit VL is arranged, and is connected with the first reset segment LV1 and the second reset segment LV2 through the contact holes, so that the contact holes in the display region AA are uniformly distributed, and the uniformity of morphology is ensured.

Alternatively, the first reset connection line LV3 may also be located between two adjacent circuit groups CM in the circuit region SA2, or between two adjacent circuit units CU. It may be integrally formed with the wiring units VB of the second reset segment LV2 on both sides thereof, but the connection unit VL connected to the two wiring units VB connected to the first reset connection line LV3 does not need to be disconnected.

In some embodiments of the present disclosure, as described above, if the number of the circuit regions SA2 of the secondary display region SA is two, and the two circuit regions SA2 of the secondary display region SA are separated at two sides of the light-transmitting region SA1 along the row direction X; the gap region Gap is provided between the two circuit regions SA2 and the main display region MA. Correspondingly, the number of the first reset connection lines LV3 may also be two, the first reset connection lines LV3 may be disposed in the two gap regions Gap, and the two first reset connection lines LV3 are both connected to the first reset bus BV1.

In some embodiments of the present disclosure, as shown in FIG. 1, the number of the secondary display regions SA is two, and the number of the circuit regions SA2 of each secondary display region SA is two; the gap regions Gap are provided between the circuit regions SA2 and the main display region MA, so that there are four circuit regions SA2 and four gap regions Gap. Correspondingly, the number of the first reset connection lines LV3 is four. The first reset connection line LV3 is provided in each gap region Gap, and the four first reset connection lines LV3 are electrically connected to the first reset bus BV1.

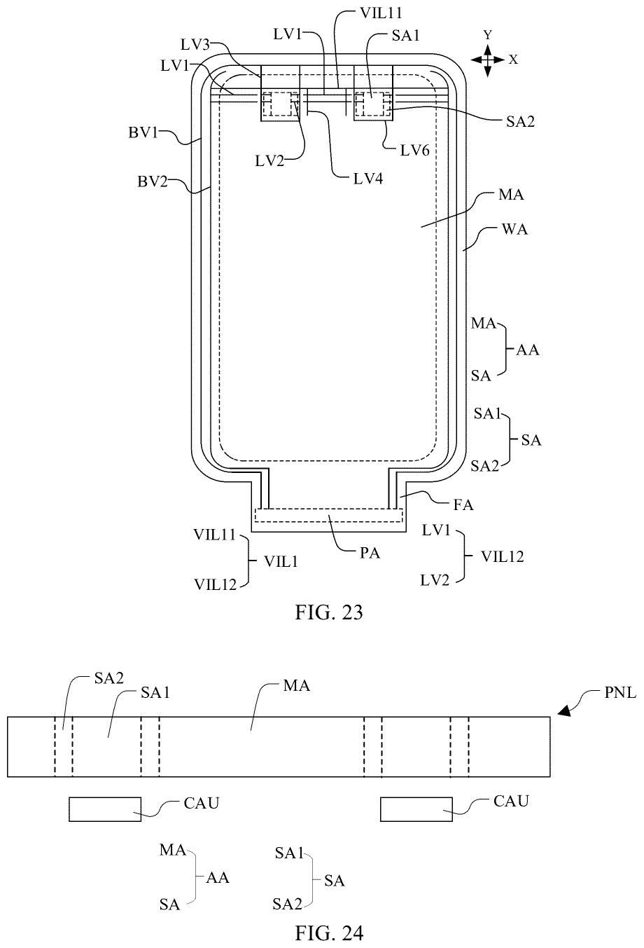

As shown in FIG. 23, the first reset connection line LV3 has a first end and a second end distributed along the column direction Y. In the two first reset connection lines LV3 located on two sides of the display region SA, first ends of the two first reset connection lines LV3 are connected to the first reset bus BV1, and second ends of the two first reset connection lines LV3 are connected through the connection wire LV6 extending along the row direction X.

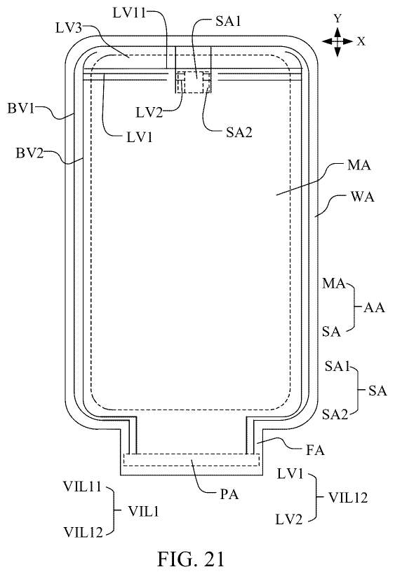

As shown in FIG. 21, for a display panel having only one secondary display region SA, the first reset segments LV1 on both sides of the secondary display region SA are disconnected at the secondary display region SA, but may extend reversely to the peripheral region WA and be connected to the second reset bus BV2, so as to receive the first reset signal VI1. However, if there are multiple secondary display regions SA linearly distributed along the row direction X, the first reset segment LV1 between two adjacent secondary display regions SA may receive the first reset signal VI1 in the following manner.

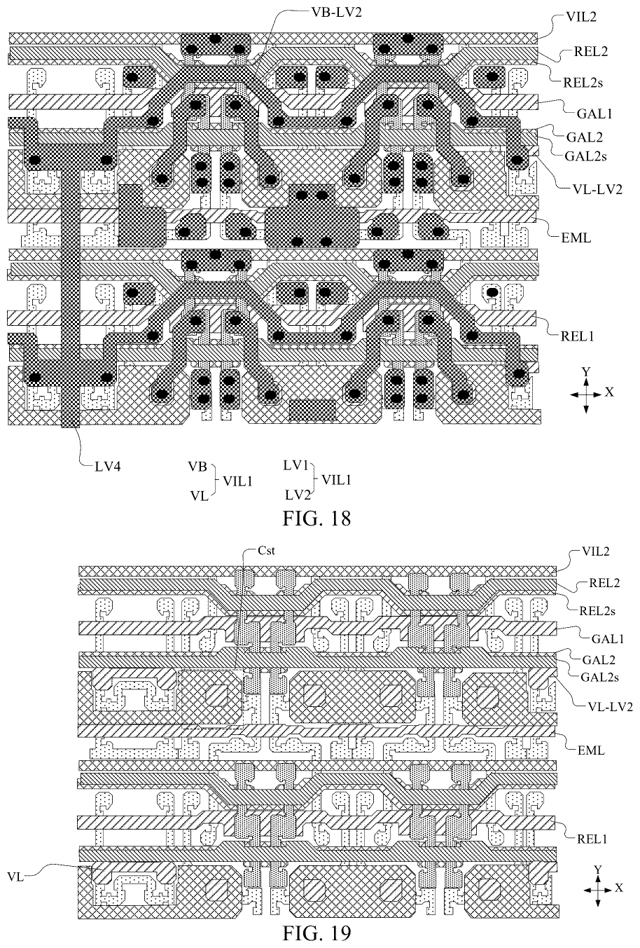

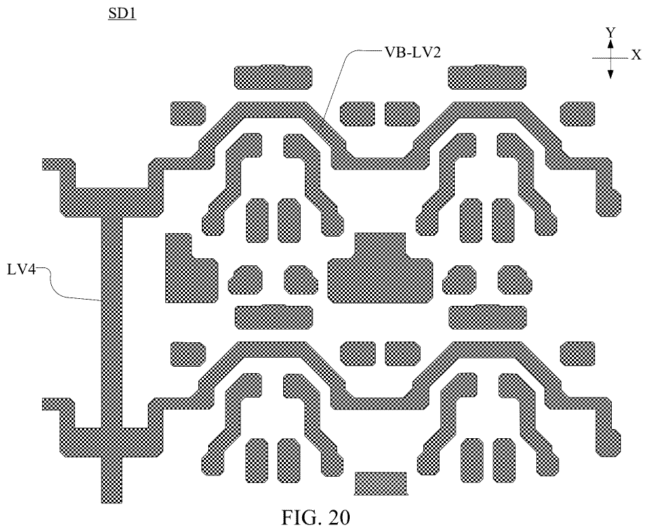

As shown in FIG. 1, FIG. 17 to FIG. 20 and FIG. 22, in some embodiments of the present disclosure, a second reset connection line LV4 extending in the column direction Y may be disposed in the main display region MA between two adjacent secondary display regions SA, and the second reset connection line LV4 is connected to at least one first reset signal line VIL1 (the first-type first reset signal line VIL11) located outside the secondary display region SA in the column direction Y. In addition, the second reset connection line LV4 is connected to the first reset segment LV1 between two adjacent secondary display regions SA, so that the second reset connection line LV4 can bypass the secondary display region SA, and the first reset signal VI1 can be transmitted to a reset segment LV1 between two adjacent secondary display regions SA.

As shown in FIG. 17 to FIG. 20, the second reset connection line LV4 and the first reset connection line LV3 may be located in the same gap region Gap, but are spaced apart from each other on a side of the first reset connection line LV3 away from the light-transmitting region SA1. Accordingly, the first reset segments LV1 between two adjacent secondary display regions SA are located at the same side of the second reset connection line LV4. Alternatively, the second reset connection line LV4 and the first reset connection line LV3 may be separated by at least one circuit group CM, and both sides of the second reset connection line LV4 are provided with the first reset segment LV1. Accordingly, the second reset connection line LV4 intersects with the connection unit VL of the first reset segment LV1, and the connection unit VL intersecting with the second reset connection line LV4 is continuous in the row direction X without being unbroken, so as to ensure that the second reset connection line LV4 can transmit the first reset signal VI1 to both sides.

Further, the second reset connection line LV4 may be disposed in the same layer as the first reset connection line LV2. For example, both of them are disposed in the first source-drain layer SD1 and may be disposed in the same layer as the wiring unit VB. The second reset connection line LV4 may be located between two adjacent circuit groups CM in the main display region MA, or may be located between two adjacent circuit units CU.

As shown in FIG. 1, there may be a plurality of second reset connection lines LV4 distributed along the row direction X. For example, there are two second reset connection lines LV4 connected to the first reset segments LV1 between two adjacent display regions SA. In addition, the two second reset connection lines LV4 may be symmetrically arranged with respect to a central axis of a region between two adjacent display regions SA along the column direction Y.

In some other embodiments of the present disclosure, the second reset connection line LV4 may also be located on a side of the wiring unit VB away from the connection unit VL. Accordingly, the second reset connection line LV4 may overlap with the pixel circuit PC, as long as the first reset signal VI1 can be transmitted to the first reset segment LV1 in the main display region MA between two adjacent secondary display regions SA.

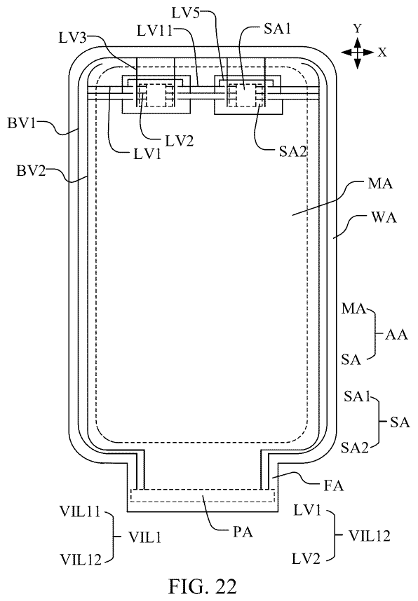

As shown in FIG. 22, in other embodiments of the present disclosure, for the first reset segments LV1 located on the same first reset signal line VIL1 and separated by the secondary display region SA, the first reset segments LV1 on both sides of the secondary display region SA may be connected by a lead LV5 bypassing the secondary display region SA, where the lead LV5 may be located in any film layer of the driving backplane BP, or may be located in any film layer between the driving backplane BP and the light-emitting device LD. Moreover, the lead LV5 may be located in a single film layer, or may include different line segments located in a plurality of film layers, as long as the lead LV5 can achieve the aforementioned connection function.

Further, as shown in FIG. 22, two first reset segments LV1 of the same first reset signal line VIL1 separated by a secondary display regions SA in the row direction X are connected through the lead LV5. At least part of the lead LV5 is located on a side of the first reset segment LV1 connected thereto close to the fan-out region FA, or at least part of the lead LV5 is located on a side of the first reset segment LV1 connected thereto away from the fan-out region FA.

For example, in some embodiments of the present disclosure, each of the leads LV5 may be divided into two parts, and the number of the leads LV5 of the two parts may be the same or different; wherein part of the leads LV5 are located on a side of the first reset segment LV1 connected thereto close to the fan-out region FA, and another part of the leads LV5 are located on a side of the first reset segment LV1 connected thereto away from the fan-out region FA, thereby preventing the leads LV5 from being too concentrated, so as to make full use of space for wiring.

In some embodiments of the present disclosure, each lead LV5 is located on a side of the first reset segment LV1 connected thereto close to the fan-out region FA.

In some embodiments of the present disclosure, each lead LV5 is located on a side of the first reset segment LV1 connected thereto away from the fan-out region FA.

Some embodiments of the present disclosure further provide a display device, which may be a mobile phone, a tablet computer, a television or other electronic devices with an under-screen camera function, and will not be enumerated here. As shown in FIG. 23, the display device of the present disclosure may include a display panel PNL and a photosensitive element CAU.

The display panel PNL is the display panel PNL according to any of the above embodiments, and the structure thereof may refer to the above embodiments of the display panel PNL, which will not be described in detail herein.

The photosensitive element CAU may be disposed on a side of the driving backplane BP away from the light-emitting device LD, and an orthographic projection of the photosensitive element CAU on the driving backplane BP at least partially overlaps an orthographic projection of the light-transmitting region SA1 on the driving backplane BP.

In some embodiments of the present disclosure, there are a plurality of secondary display regions SA, the number of the photosensitive elements CAU is the same as the number of the secondary display regions SA, and the photosensitive elements CAU are overlapped with the light-transmitting regions SA1 of the secondary display regions SA in one-to-one correspondence.

The external light may pass through the light-transmitting region SA1 to irradiate the corresponding photosensitive element CAU, and the photosensitive element CAU may generate an electrical signal according to the light passing through the corresponding light-transmitting region SA1, so as to generate an image. The photosensitive element CAU may include an image sensor, such as a CCD image sensor or a CMOS image sensor.

The photosensitive element CAU may generate an image based on visible light, and may further generate an image based on infrared rays or other light rays. For example, the photosensitive element CAU may include an infrared sensor, which is configured to form an infrared image by receiving external infrared rays, so as to identify a fingerprint pattern, an iris pattern, a face pattern, and the like according to the infrared image. Alternatively, the photosensitive element CAU may further include an illuminance sensor, which may be configured to measure the illuminance around the display device, and the display panel PNL may adjust the brightness of the display panel based on the measured illuminance. In addition, the photosensitive element CAU may also be provided with a LIDAR (Light Detection and Ranging) sensor or the like.

The photosensitive element CAU not only can be used for a camera for taking images, but also can be used for measuring distance by outputting and detecting light, or used for a small lamp for outputting light.

Other embodiments of the disclosure will be readily apparent to those skilled in the art upon consideration of the specification and practice of the inventions disclosed herein. This application is intended to cover any variations, uses, or adaptations of the disclosure that follow the general principles of the disclosure and include common knowledge or conventional technical means in the art not disclosed in the disclosure. The specification and examples are to be regarded as exemplary only, and the true scope and spirit of the present disclosure are indicated by the appended claims.

1. A display panel, having a display region and a peripheral region at least partially surrounding the display region, wherein the display region comprises a secondary display region and a main display region located on at least one side of the secondary display region, and the secondary display region comprises a light-transmitting region and a circuit region located on at least one side of the light-transmitting region; wherein the display panel comprises:
a driving backplane, comprising a plurality of pixel circuits distributed in an array and a plurality of first reset signal lines, wherein the pixel circuits comprise first pixel circuits and a second pixel circuit, the first pixel circuits are located in the main display region and the circuit region, the second pixel circuit is located in the circuit region; the plurality of first reset signal lines extend along a first direction, the plurality of first reset signal lines comprises a first-type first reset signal line and a second-type first reset signal line; the second-type first reset signal line comprises a first reset segment and a second reset segment intermittently arranged along the first direction, the first reset segment is located in the main display region, and the second reset segment is located in the circuit region; and
a plurality of light-emitting devices, located on one side of the driving backplane, and comprising first light-emitting devices located in the main display region and the circuit region, and a second light-emitting device located in the light-transmitting region; the first light-emitting devices are connected to the first pixel circuits, and the second light-emitting device is connected to the second pixel circuit through a connecting line;
wherein the first reset segment is connected to part of the first pixel circuits in the main display region, and the first reset segment is configured to provide a first reset signal to the first pixel circuits in the main display region; the second reset segment is connected to the second pixel circuit and the first pixel circuits in the circuit region, and the second reset segment is configured to provide a second reset signal to the second pixel circuit and the first pixel circuits in the circuit region.

2. The display panel according to claim 1, wherein the driving backplane further comprises:
a first reset bus, located in the peripheral region;
a second reset bus, located in the peripheral region and spaced apart from the first reset bus, wherein the second reset bus is connected to the first reset segment in the main display region; and
a first reset connection line, extending from the peripheral region to the display region along a second direction, wherein the first reset connection line connects the first reset bus with the second reset segment;
wherein the first direction intersects with the second direction.

3. The display panel according to claim 2, wherein in the first direction, a gap region extending along the second direction is provided between the main display region and the circuit region, and the first reset connection line is located within the gap region.

4. The display panel according to claim 3, wherein a number of the circuit region in the secondary display region is two, and the two circuit regions are respectively located on both sides of the light-transmitting region along the first direction; two gap regions are respectively provided between the two circuit regions and the main display region;
the first reset connection line is provided in the two gap regions, and the first reset connection line is connected to the first reset bus.

5. The display panel according to claim 4, wherein a number of the secondary display region is two, and a number of the first reset connection line is four; the first reset connection lines are respectively provided in each of the gap regions, and the four first reset connection lines are all connected to the first reset bus.

6. The display panel according to claim 5, wherein with respect to two first reset connection lines located on both sides of one of the secondary display regions, first ends of the two first reset connection lines are connected to the first reset bus, and second ends of the two first reset connection lines are connected through a connecting wire extending along the first direction.

7. The display panel according to claim 4, wherein the peripheral region comprises a fan-out region extending in a direction away from the display region;
the first reset bus comprises a first bus segment, a second bus segment and a third bus segment, wherein the first bus segment and the second bus segment are located on both sides of the display region and extend to the fan-out region, the third bus segment is located on a side of the display region away from the fan-out region and connects the first bus segment with the second bus segment, and the first reset connection line is connected to the third bus segment,
the second reset bus is located on both sides of the display region and extends to the fan-out region, the second reset bus is disconnected on a side of the display region away from the fan-out region, and the first reset connection line passes through a disconnected position of the second reset bus.

8. The display panel according to claim 7, wherein a number of the secondary display region is multiple, and the multiple secondary display regions are spaced apart along the first direction;
the main display region between two adjacent secondary display regions is provided with a second reset connection line extending along the second direction; at least one of the first-type first reset signal line is connected to the first reset segment between the two adjacent secondary display regions through the second reset connection line.

9. The display panel according to claim 8, wherein a number of the second reset connection line between the two secondary display regions is two, and the two second reset connection lines are spaced apart along the first direction; the first reset segment between the two adjacent secondary display regions are connected through the two second reset connection lines.

10. The display panel according to claim 7, wherein two first reset segments of a single first reset signal line separated by one of the secondary display regions in the first direction are connected through a lead; at least part of the lead is located on a side, close to the fan-out region, of the first reset segment connected to the lead, or at least part of the lead is located on a side, away from the fan-out region, of the first reset segment connected to the lead.

11. The display panel according to claim 8, wherein the first reset signal line comprises a plurality of wiring units distributed along the first direction and a connection unit connected to two adjacent wiring units, and the connection unit and the wiring units are located on different layers;
both the first reset segment and the second reset segment comprise the plurality of wiring units and the connection unit;
in the first reset signal line having the first reset segment and the second reset segment, the connection unit is intermittently provided in the gap region, one end of the connection unit is connected to one of the wiring units in the first reset segment, and another end of the connection unit is connected to one of the wiring units in the second reset segment;
the first reset connection line intersects with the intermittently provided connection unit.

12. The display panel according to claim 11, wherein the wiring units, the first reset connection line and the second reset connection line are arranged on a same layer, and are located on a side of the connection unit close to the light-emitting devices.

13. The display panel according to claim 11, wherein the first reset connection line and the second reset connection line are arranged on a same layer, and are located on a side of the wiring units away from the connection unit.

14. The display panel according to claim 11, wherein the second reset connection line is disposed across and connected to part of the connection unit.

15. The display panel according to claim 3, wherein the pixel circuits are divided into a plurality of circuit groups distributed in an array; one of the circuit groups comprises a plurality of circuit units distributed along the first direction; and one of the circuit units comprises two of the pixel circuits distributed along the first direction;
in the first direction, a distance between two adjacent circuit groups is greater than a distance between two adjacent pixel circuits; two pixel circuits of a single circuit unit are symmetrically arranged relative to a straight line extending along the second direction;
the gap region is a partial region between two adjacent circuit groups.

16. The display panel according to claim 12, wherein the pixel circuit comprises a first reset transistor;
in the circuit region, the second reset segment is connected to the light-emitting device through the first reset transistor;
in the main display region, the first reset segment is connected to the light-emitting device through the first reset transistor.

17. The display panel according to claim 1, further comprising:
a connecting layer, provided between the driving backplane and the light-emitting devices, and comprising the connecting line, wherein the connecting line extends from the circuit region to the light-transmitting region, and at least one of the second light-emitting device is connected to at least one of the second pixel circuit through at least one of the connecting line.

18. A display device comprising:
the display panel according to claim 1; and
a photosensitive element, located on a side of the driving backplane away from the plurality of light-emitting devices, wherein an orthographic projection of the photosensitive element on the driving backplane at least partially overlaps with an orthographic projection of the light-transmitting region on the driving backplane.
